(19) United States
(12) Patent Application Publication
(10) Pub. No.: US 2009/0130532 A1
(43) Pub. Date: May 21, 2009

(54) Mixing Pump Device and Fuel Cell

(75) Inventors: Mitsuo Yokozawa, Nagano (JP); Kenji Muramatsu, Nagano (JP); Katsumi Kozu, Osaka (JP); Toshihiko Ichinose, Osaka (JP)

Correspondence Address: FLYNN THIEL BOUTELL & TANIS, P.C., 2026 RAMBLING ROAD, KALAMAZOO, MI, 49008-1631, US

(73) Assignee: NIDEC SANKYO CORPORATION, Nagano (JP)

(21) Appl. No.: 12/083,991

(22) PCT Filed: Feb. 9, 2007
(86) PCT No.: PCT/JP2007/000074

§ 371 Date: Apr. 22, 2008

(30) Foreign Application Priority Data
Feb. 13, 2006 (JP) 2006-035698
Nov. 8, 2006 (JP) 2006-302940

(51) Int. Cl. H01M 8/04; F04B 43/02; F04B 49/22; F04B 49/20

(52) U.S. Cl. 429/34; 417/321; 417/472; 417/317

(57) ABSTRACT

In a mixing pump device (1), during an suctioning step a stepping motor (12) rotates in a first direction, so that during this time, a plurality of fluids can be drawn in prescribed proportions into a pump chamber (2), by sequentially opening and closing active valves (5a, 5b) situated in inflow passages (3a, 3b) while active valves (6a, 6b) situated in outflow passages (4a, 4b) are in a closed state. During the discharging step the stepping motor (12) rotates in a second direction, so that during this time, a mixed fluid can be discharged from the pump chamber (2) simply by sequentially opening the active valves (6a, 6b) situated in the outflow passages (4a, 4b), while the active valves (5a, 5b) situated in the inflow passages (3a, 3b) are in a closed state. It is possible thereby to achieve a mixing pump device capable of mixing a plurality of fluids in prescribed proportions, without detecting the operating stage of the pump.

### TECHNICAL FIELD

The present invention relates to a mixing pump device for suctioning and mixing a plurality of fluids and then discharging them, as well as to a fuel cell for use as a fuel delivery device for delivering fuel to the electromotive part of the mixing pump device.

### BACKGROUND ART

One mixing pump device known in the art for mixing a plurality of fluids in prescribed proportions is an apparatus designed to suction a plurality of fluids into a single pump chamber, mix them in the pump chamber to form a mixed fluid, then discharge the mixed fluid from the pump chamber. Patent Citation 1 discloses a mixing pump device in a high-performance liquid chromatography device, for suctioning in and mixing several types of solvents with a plunger pump, and discharging the mixed fluid obtained thereby to the column.

The mixing pump device disclosed therein is designed to transmit rotation of a stepping motor to the plunger via a cam mechanism, increasing or decreasing the internal volume of the pump chamber. In the fluid suctioning step, during expansion of the pump chamber, valves positioned on each of two inflow passages communicating with the pump chamber are opened in sequence, and the fluids are suctioned via the inflow passages into the pump chamber where they are mixed. Subsequently, a discharge process is carried out, constricting the pump chamber and discharging the mixed liquid.

### [Patent Citation 1] JP 3117623 B

In the mixing pump device disclosed in Patent Citation 1, rotational motion of the stepping motor in one direction is converted to reciprocating motion of the plunger via the cam mechanism, thereby increasing and decreasing the internal volume of the pump chamber. For this reason, detection means will be required for detecting the position of the cam by means of a photointerrupter or the like, and detecting the operating phase of the pump based on the position of the cam. This need for a mechanism to detect the operating phase of the pump makes the design of the device more complex, and complicates efforts to reduce size and cost.

### DISCLOSURE OF THE INVENTION

An object of the present invention is to provide a mixing pump device capable of mixing and delivering a plurality of fluids in prescribed proportions without detecting the operating phase of the pump, as well as a fuel cell having this mixing pump device.

In order to solve the aforementioned problem, the mixing pump device of the present invention comprises: a pump chamber; a displacing member disposed in the pump chamber, for increasing and reducing the internal volume of the pump chamber; a drive unit having a motor for inducing displacement of the displacing member; a plurality of inflow passages communicating with the pump chamber; at least one outflow passage communicating with the pump chamber; inflow valves disposed on the inflow passages, for independently opening and closing the inflow passages; an outflow valve for opening and closing the outflow passage; and a control unit for controlling the drive unit, the inflow valves, and the outflow valve. The drive unit induces displacement of the displacing member in a direction for increasing the internal volume of the pump chamber when the motor turns in a first direction; and induces displacement of the displacing member in a direction for reducing the internal volume of the pump chamber when the motor turns in a second direction.

In the suctioning step of the mixing pump device of the invention, by closing the valve on the outflow end and inducing displacement of the displacing member while sequentially opening and closing the valves on the inflow end, fluids can be suctioned successively into the pump chamber from the plurality of inflow passages, and mixed inside the pump chamber. In the discharging step, by closing the valves on the inflow end and inducing displacement of the displacing member in the opposite direction with the valve on the inflow end open, the fluid in the pump chamber can be discharged to the outflow passage.

The drive unit induces displacement of the displacing member in the direction for increasing the internal volume of the pump chamber when the motor turns in a first direction; and induces displacement of the displacing member in the direction for reducing the internal volume of the pump chamber when the motor turns in a second direction which is the opposite of the first direction. Thus, the interval during which the motor turns in the first direction constitutes the suctioning step, and the interval during which it turns in the second direction constitutes the discharging step. Consequently, there is no need to detect the displacement position of the displacing member, or to detect the position of a power transmission component or the like linked to the displacing member. Therefore, there is no need for a detection mechanism equipped with a photointerrupter or the like for detecting the position of the cam etc., such as is required in a conventional mixing pump device that transmits rotation in one direction by the motor to the plunger via a cam mechanism; and it is possible for the mixing pump device to be smaller and more compact.

Here, a plurality of the outflow passages may communicate with the pump chamber, and the outflow valves may be positioned on the outflow passages.

Moreover, the inflow passages and the outflow passages may communicate mutually independently with the pump chamber.

Furthermore, a diaphragm may be used as the displacing member.

Next, during the suctioning step in which, with the outflow valve open, the displacing member is induced to undergo displacement in the direction for increasing the internal volume of the pump chamber, the control unit will control opening and closing of the inflow valves in such a way that, among the fluids flowing in from the respective inflow passages, before the fluid having the lowest mixture proportion inflows to the pump chamber, at least some fluid having a larger mixture proportion than that fluid will flow into the pump chamber. By controlling the suctioning operation of fluids into the pump chamber in this manner, the suctioned fluids can be mixed well without becoming distributed unevenly in the pump chamber.

Additionally, the control unit, by controlling the inflow of the fluids flowing into the pump chamber from the inflow passages, respectively controls the mixture proportions of the fluids making up the mixed fluid which is produced in the pump chamber, and the discharge of the mixed fluid which is discharged to the outflow passage from the pump chamber.

Next, the fuel cell of the present invention has an electromotive part and a fuel delivery device for delivering fuel to the electromotive part, wherein the fuel delivery device is a mixing pump device of the above design.

Here, the fuel used in the fuel cell is a hydrogen-containing fluid capable of generating protons. In this case, the hydrogen-containing fluid will preferably contain an alcohol. For example, the hydrogen-containing fluid will preferably contain methyl alcohol and/or ethyl alcohol, and preferably aqueous solutions of these alcohols. Alcohols such as these require little energy to generate protons, and thus power generation efficiency can be improved. An ethylene glycol aqueous solution or dimethyl ether aqueous solutions may also be used as the hydrogen-containing fluid (fuel).

The fuel cell may further have an unprepared fuel tank for delivering unprepared fuel to the pump chamber of the mixing pump device; and the plurality of inflow passages include an unprepared fuel inflow passage for the unprepared fuel delivered from the unprepared fuel tank to inflow to the pump chamber, and a diluent inflow passage for a diluent containing water to inflow to the pump chamber.

According to such an arrangement, it is possible to mix unprepared fuel delivered from the unprepared fuel tank via the unprepared fuel inflow passage with a diluent delivered via the diluent inflow passage, and deliver a fuel of optimal composition. Here, the unprepared fuel could be an alcohol or an alcohol solution of higher concentration than the optimal concentration; and the diluent could be water or an alcohol solution of lower concentration than the optimal concentration. Where the unprepared fuel is an alcohol aqueous solution of optimal concentration, the alcohol aqueous solution may be delivered to the electromotive portion without being diluted.

Here, water containing evolved water that evolved in the electromotive portion can be delivered into the pump chamber via the diluent inflow passage. For example, evolved water that evolved in the electromotive portion could be recovered in a water tank and then introduced into the pump chamber from the water tank via the diluent inflow passage. According to such an arrangement, evolved water that evolved in the electromotive portion can be reused efficiently, so discharge of water can be kept to a minimum, or eliminated altogether.

Next, where a plurality of the outflow passages communicate with the pump chamber, one of the outflow passages can be used as a coolant outflow passage for delivering a coolant to the electromotive portion. According to such an arrangement, cooling of the electromotive portion can be carried out by the mixing pump device embodying the invention, eliminating the need for a dedicated coolant delivery unit.

Where cooling is carried out in this manner, in preferred practice, only water will be drawn in from the inflow passage, and the coolant outflow passage will deliver cooling water as the coolant to the electromotive portion. According to such an arrangement, the cooling water can also be recovered for use as the diluent. Specifically, cooling water that has cooled the electromotive portion can be recovered in a water tank, and the recovered water then introduced from the water tank to the pump chamber via the coolant inflow passage. With this arrangement, the cooling water can be reused efficiently, so discharge of water can be kept to a minimum, or eliminated altogether.

According to the mixing pump device of the present invention, in the suctioning step the motor turns in a first direction, and in the discharging step the motor turns in a second direction. Consequently, and in contrast to an arrangement whereby rotation of the motor in one direction is transmitted to the plunger via a cam mechanism, there is no need to monitor the position of the cam, plunger, or the like by means of a detection mechanism equipped with a photointerrupter or the like. Thus, according to the present invention, it is possible to simplify the design of the device, and thereby make it smaller and less expensive.

Meanwhile, where the mixing pump device of the invention is used as the fuel delivery unit of a fuel cell, the unprepared fuel and the diluent can be mixed and a fuel of optimal composition delivered to the electromotive portion. Moreover, the water evolved in the electromotive portion can be reused as the coolant. Furthermore, cooling water can be delivered from the mixing pump device to the electromotive portion, and the cooling water recovered and reused as the diluent.

### BRIEF DESCRIPTION OF THE DRAWINGS

FIG. 1 is a conceptual diagram showing the basic configuration of a mixing pump device embodying the present invention;

FIG. 2A and FIG. 2B are respectively a timing chart depicting operation of the mixing pump device shown in FIG. 1, and a descriptive diagram depicting the relationship of the position of the piston to resolution;

FIGS. 3A to 3D are descriptive diagrams relating to deformation of a diaphragm;

FIG. 4 is a conceptual diagram showing the basic configuration of a mixing pump device embodying the present invention;

FIG. 5A and FIG. 5B are respectively a perspective view of a mixing pump device embodying the present invention, and a descriptive diagram showing the flow passages thereof in plan view;

FIG. 6 is an exploded perspective view of the mixing pump device of FIG. 5, viewed from diagonally above;

FIG. 7 is a descriptive diagram showing in cross section the configuration of the mixing pump device of FIG. 5A;

FIG. 8 is an exploded perspective view of the mixing pump device of FIG. 5A, shown divided on the vertical;

FIG. 9A and FIG. 9B are respectively a descriptive diagram of the pump chamber in a state of expanded internal volume, and the pump chamber in a state of contracted internal volume, in the mixing pump device of FIG. 8;

FIGS. 10A to 10C are respectively a perspective view, a plan view, and a sectional view of a rotor employing the rotating body of the pump mechanism shown in FIG. 8;

FIGS. 11A to 11C are respectively a perspective view, a plan view, and a sectional view of a moving body employing the rotating body of the pump mechanism shown in FIG. 8;

FIG. 12 is a descriptive diagram of the principal parts of a valve used for the active valves 5, 6 of the mixing pump device embodying the invention, shown cut along the axis and viewed from diagonally above;

FIG. 13 is a descriptive diagram of the lines of magnetic force of the valve shown in FIG. 12; and

FIG. 14 is a block diagram depicting in model form the structure of a fuel cell employing the mixing pump device of the present invention.

### BEST MODE FOR CARRYING OUT THE INVENTION

The present invention will be described hereinbelow with reference to the accompanying drawings.

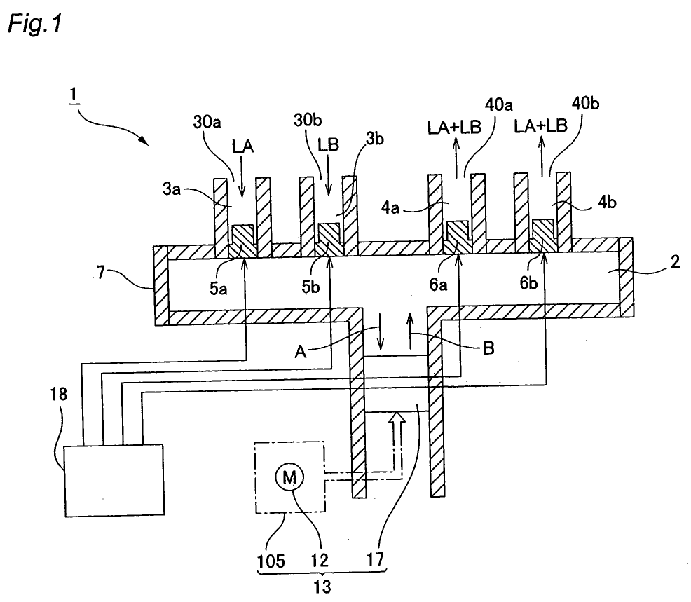

FIG. 1 is a conceptual diagram showing the basic configuration of a mixing pump device embodying the present invention. As illustrated in FIG. 1, the mixing pump device 1 has a pump chamber 2. In the pump chamber 2 there are formed a plurality (two, in this example) of intake ports 30a, 30b; and a plurality (two, in this example) of discharge ports 40a, 40b. The intake ports 30a, 30b communicate respectively with inflow passages 3a, 3b; and the discharge ports 40a, 40b communicate respectively with outflow passages 4a, 4b. The pump device main unit 7 is made up of the pump chamber 2, the intake ports 30a, 30b, the discharge ports 40a, 40b, the inflow passages 3a, 3b, and the outflow passages 4a, 4b.

Inflow-side active valves 5a, 5b for individually opening and closing the intake ports 30a, 30b are disposed in these ports. Outflow-side active valves 6a, 6b for individually opening and closing the discharge ports 40a, 40b are disposed in these ports. These inflow-side active valves 5a, 5b and outflow-side active valves 6a, 6b are opened and closed by means of a control unit 18.

A portion of the inside peripheral surface of the pump chamber 2 is defined by a displacing member 17 such as a piston or diaphragm. The displacing member 17 is displaceable in the outward and inward direction of the pump chamber; in the present example, the displacing member 17 undergoes displacement by means of a drive unit 105 equipped with a stepping motor 12. The pump drive mechanism 13 is composed of this displacing member 17 and drive unit 105. When the stepping motor 12 of the drive unit 105 turns in one direction, the displacing member 17 is displaced in the direction A of increasing internal volume of the pump chamber 2; and when the stepping motor 12 turns in the opposite direction, the displacing member 17 is displaced in the direction B of decreasing internal volume of the pump chamber 2.

During the suctioning step of the mixing pump device 1 of this design, for example, with one inflow-side active valve 5a open, and with the other inflow-side active valve 5b and the outflow-side active valves 6a, 6b closed by the control unit 18, the displacing member 17 undergoes displacement towards direction A by means of the drive unit 105, thereby suctioning a fluid LB into the pump chamber 2 from the inflow passage 3b via the intake port 30b. Next, by switching the open/closed states of the inflow-side active valves 5a, 5b and displacing the displacing member 17 further towards direction A, another fluid LA is suctioned into the pump chamber 2 from the inflow passage 3a via the intake port 30a. The fluids LA, LB are mixed within the pump chamber 2.

During the discharging step of the mixing pump device, for example, with one outflow-side active valve 6a open, and with the other outflow-side active valve 6b and the inflow-side active valves 5a, 5b closed by the control unit 18, the displacing member 17 undergoes displacement towards direction B via the drive unit 105, thereby discharging the mixed fluid from the pump chamber 2 into the outflow passage 4a via the discharge portion 40a. By switching the open/closed states of the outflow-side active valves 6a, 6b and displacing the displacing member 17 further towards direction B, the mixed fluid can be discharged to the outflow passage 4b from the other discharge port 40b.

In this mixing pump device 1, a correcting step, discussed below, is executed in the interval between the suctioning step and the discharging step.

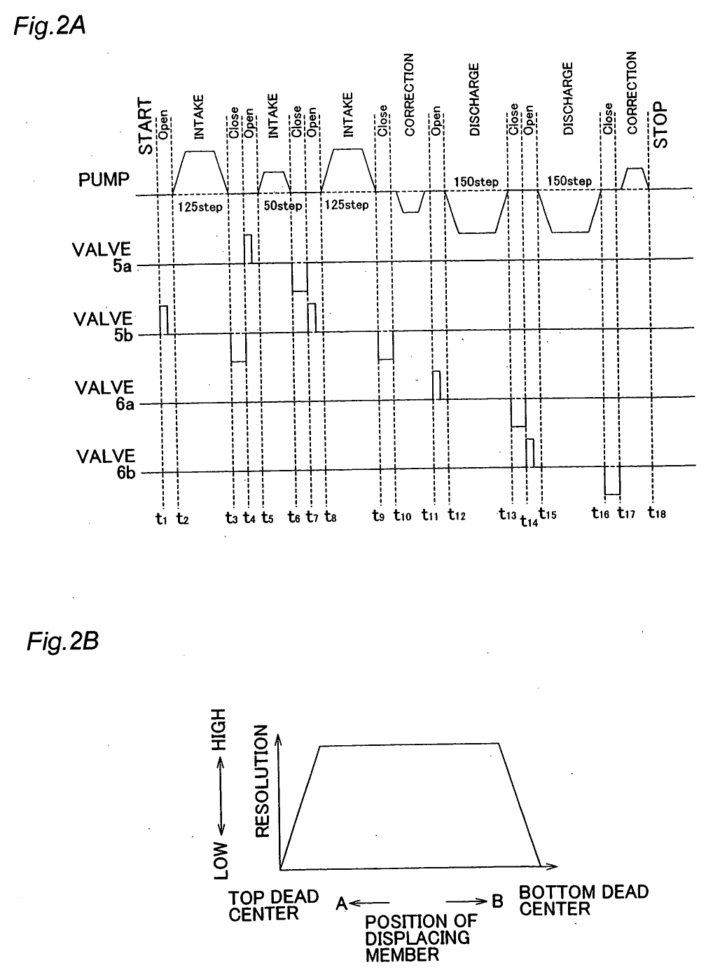

FIGS. 2A and 2B are respectively a timing chart depicting operation of the mixing pump device shown in FIG. 1, and a descriptive diagram depicting the relationship of the position of the displacing member to resolution. The operation of the mixing pump device 1 will be described in detail with reference to FIG. 2A. In the description hereinbelow, the proportion of inflow (mixture proportion) of the first fluid LA and the second fluid LB taken in via the two inflow passages 3a, 3b is assumed to be 1:5.

In FIG. 2A, the uppermost level shows the intake operation and discharge operation by the pump drive mechanism 13; the intake operation by the pump drive mechanism 13 is accomplished, for example, by clockwise rotation of the stepping motor 12 displacing the displacing member 17 in the direction A of increasing the internal volume of the pump chamber 2 (see FIG. 1). The discharge operation by the pump drive mechanism 13 is accomplished, for example, by counterclockwise rotation of the stepping motor 12 displacing the displacing member 17 in the direction B of decreasing the internal volume of the pump chamber 2 (see FIG. 1). The pump drive mechanism 13 is halted via suspending the power supply to the stepping motor 12.

The inflow-side active valves 5a, 5b and the outflow-side active valves 6a, 6b all assume the open state once a positive pulse has been input, switching to the closed state at the point in time that a negative pulse is input. Once a negative pulse has been input, the valves assume the closed state once a positive pulse has been input, switching to the open state at the point in time that a negative pulse is input.

In FIG. 2A, first, at time t1, power to the stepping motor 12 is suspended, and the pump drive mechanism 13 comes to a stop. At time t1, all of the active valves 5a, 5b, 6a, 6b are in the closed state.

In this state, at time t1, of the two inflow-side active valves 5a, 5b, only the inflow-side active valve 5b located in the inflow passage 3b which corresponds to the liquid LB is switched to the open state. Next, at time t2, power is supplied to the stepping motor 12, and the stepping motor 12 rotates clockwise displacing the displacing member 17 in the direction A of increasing the internal volume of the pump chamber 2. As a result, the liquid LB flows into the pump chamber 2 from the inflow passage 3b. At time t3 following input of a 125-step pulse to the stepping motor 12, power to the stepping motor 12 is suspended, and the displacing member 17 comes to a halt as well. At the same time, the inflow-side active valve 5b is switched from the open state to the closed state. As a result, the flow of the liquid LB into the pump chamber 2 from the inlet passage 3b halts. According to this intake operation, one-half of the total inflow amount of the liquid LB is drawn into the pump chamber 2.

Next, at time t4, only the inflow-side active valve 5a is switched to the open state; and at time t5 power is supplied to the stepping motor 12, and the stepping motor 12 rotates in the same direction (clockwise) displacing the displacing member 17 in the same direction (the direction A of increasing the internal volume of the pump chamber 2). As a result, the liquid LA flows into the pump chamber 2 from the inflow passage 3a. Then, at time t6 following input of a 50-step pulse to the stepping motor 12, power to the stepping motor 12 is suspended, and the displacing member 17 comes to a halt as well. At the same time, the inflow-side active valve 5a is switched from the open state to the closed state. As a result, the flow of the liquid LA into the pump chamber 2 from the inlet passage 3a halts. According to this intake operation, the total inflow amount of the liquid LA is drawn into the pump chamber 2.

Next, at time t7, the inflow-side active valve 5b only is again switched to the open state, and at time t8 power is supplied to the stepping motor 12, whereupon the stepping motor 12 rotates in the same direction (clockwise). The displacing member 17 is thereby displaced further in the same direction (the direction of increasing the internal volume of the pump chamber 2), and the fluid LB flows into the pump chamber 2 from the inlet passage 3b. Then, at time t9 following input of a 125-step pulse to the stepping motor 12, power to the stepping motor 12 is suspended, and the displacing member 17 comes to a halt as well. At the same time, the inflow-side active valve 5b is switched from the open state to the closed state. As a result, the flow of the liquid LB into the pump chamber 2 from the inlet passage 3b halts. According to this intake operation, the remaining one-half of the total inflow amount of the liquid LB is drawn into the pump chamber 2.

After completion of the suctioning step in the above manner, during time t10 and time t11, the correcting step is executed, followed by switchover to the discharging step. The correcting step will be discussed later; first, a description of the discharging step starting at time t11 shall be provided.

At time t11, of the two outflow-side active valves 6a, 6b, only the outflow-side active valve 6a is switched to the open state; at time t12, power is supplied to the stepping motor 12, and the stepping motor 12 rotates in the opposite direction (counterclockwise direction). The displacing member 17 is thereby displaced in the direction B of decreasing the internal volume of the pump chamber 2, and the mixed liquid in the pump chamber 2 is discharged into the outflow passage 4a. Then, at time t13 following input of a 150-step pulse to the stepping motor 12, power to the stepping motor 12 is suspended, and the displacing member 17 comes to a halt as well. At the same time, the outflow-side active valve 6a is switched from the open state to the closed state. As a result, the mixed liquid is discharged from the outflow passage 4a, in an amount equivalent to one-half the liquid that has flowed into the pump chamber 2. Subsequently, during time t17 and time t18, the correcting step is executed, and the operation concludes.

Next, at time t14, of the two outflow-side active valves 6a, 6b, only the outflow-side active valve 6b is switched to the open state; at time t15, power is supplied to the stepping motor 12, and the stepping motor 12 rotates in the same direction (counterclockwise direction), displacing the displacing member 17 further in the direction B of decreasing the internal volume of the pump chamber 2, and discharging the mixed liquid in the pump chamber 2 into the outflow passage 4b. Then, at time t16 following input of a 150-step pulse to the stepping motor 12, power to the stepping motor 12 is suspended, and the displacing member 17 comes to a halt. At the same time, the outflow-side active valve 6b is switched from the open state to the closed state. As a result, the mixed liquid is discharged from the outflow passage 4b, in an amount equivalent to one-half the liquid that has flowed into the pump chamber 2. Subsequently, during time t17 and time t18, the correcting step is executed, and the operation concludes.

The correcting step which is performed during the interval of time t10 to t11 and during the interval of time t17 to t18 will now be described. At points in time of switchover of the direction of displacement of the displacing member 17, specifically, at top dead center during switchover from the suctioning step to the discharging step, and at bottom dead center during switchover from the discharging step to the suctioning step, there is a tendency for resolution of positioning to be low, as shown in FIG. 2B. In the case where a gear mechanism is used as the drive unit 105 for example, this tendency could be caused by backlash. The displacing member 17 is also susceptible to delayed response to operation and slipping out of position at top dead center and bottom dead center.

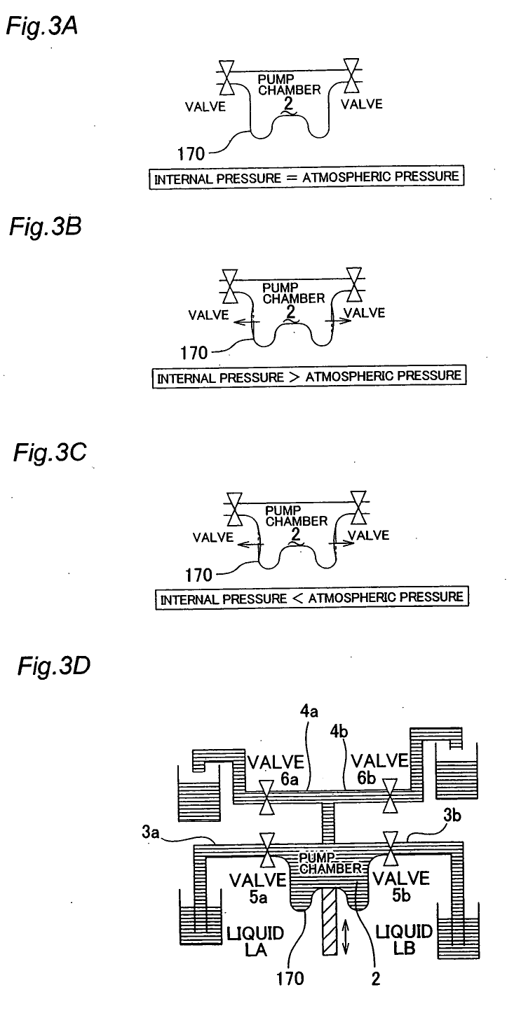

Particularly where a diaphragm is employed as the displacing member 17, delayed response to displacement tends to occur at top dead center and bottom dead center, where the direction of displacement of the diaphragm changes. Also, the shape of the diaphragm is susceptible to a pressure difference between the internal pressure of the pump chamber 2 and atmospheric pressure. This point shall be discussed with reference to FIGS. 3A to 3D.

Where, for example, the internal pressure of the pump chamber 2 is equal to atmospheric pressure as illustrated in FIG. 3A, the diaphragm 170 will not experience any unintended displacement due to a pressure difference. Where the internal pressure of the pump chamber 2 is greater than atmospheric pressure as illustrated in FIG. 3B, the diaphragm 170 becomes distended due to the pressure difference. Conversely, where the internal pressure of the pump chamber 2 is lower than atmospheric pressure as illustrated in FIG. 3C, the diaphragm 170 becomes constricted by the equivalent of the pressure difference.

Consequently, when the pump chamber 2 is at negative pressure upon completion of the suctioning step at time t9, the diaphragm will tend to assume the condition depicted in FIG. 3C. Or, when the pump chamber 2 is at positive pressure upon completion of the discharging step at time t16, the diaphragm will tend to assume the condition depicted in FIG. 3B. Thus, if in the condition depicted in FIG. 3C, the outflow-side active valve 6a is opened at time t11 and the pump chamber 2 now communicates with the outflow passage 4a to the outflow port 40a end thereof with respect to the valve 6a, there is a risk that the mixed fluid in the outflow passage 4a on the outflow port 40a end thereof will backflow into the pump chamber 2 due to the differential head. If such a condition occurs, the discharged amount of the mixed liquid will be less than the intended amount. If in the condition depicted in FIG. 3B, the inflow-side active valve 5b is opened at time t1 and the pump chamber 2 now communicates with the inflow passage 3b to the outflow inflow port 30b end thereof with respect to the valve 5b, the mixed liquid in the pump chamber 2 will backflow from the inflow passage 3b, and the inflowing amount of the second liquid LB will be less than the intended amount.

Meanwhile, even in instances where the pump chamber 2 is at a pressure equal to atmospheric pressure upon completion of the suctioning step at time t9 or upon completion of the discharging step at time t16, a problem such as is described hereunder may occur where the outflow passages 4a, 4b are situated above and the inflow passages 3a, 3b are situated below as depicted in FIG. 3D. First, upon completion of the intake at time t9, since the pressure of the pump chamber 2 equals the pressure to the outside of the inflow-side active valve 5b, when the outflow-side active valve 6a is opened at time t11 and the pump chamber 2 communicates with the outflow port 40a end of the outflow passage 4a, there is a risk that the fluid mixed at the outflow port 40b via the valve 6a of the outflow passage 4a will flow back into the pump chamber 2 due to the differential head. If such a condition occurs, the diaphragm 170 will become distended prior to actuation of the diaphragm 170, and the discharged amount of the mixed liquid will be less than the intended amount. Also, even where the pump chamber 2 is at a pressure equal to atmospheric pressure upon completion of the discharging step at time t16, after completion of the discharging step at time t16, since the pressure of the pump chamber 2 equals the pressure to the outside of the outflow-side active valve 6b, when during the second intake cycle the inflow-side active valve 5b is opened at time t1 and the pump chamber now communicates with the inflow port 30b end of the inflow passage 3b, there is a risk that the mixed liquid will backflow through the inflow passage 3b. If such a condition occurs, the diaphragm 170 will become indented prior to actuation of the diaphragm 170, and the inflow amount of the liquid LB will be less than the intended amount.

In order to avoid such adverse effects, a correcting step for the purpose of correcting the position of the displacing member 17 is executed during switchover from the suctioning step to the discharging step, and during switchover from the discharging step to the suctioning step. During switchover from the suctioning step to the discharging step, the displacing member 17 undergoes displacement to a slight extent in the direction for reducing the internal volume of the pump chamber 2, whereas during switchover from the discharging step to the suctioning step the displacing member 17 undergoes displacement to a slight extent in the direction for increasing the internal volume of the pump chamber 2.

Turning now to a more detailed description, as shown in FIG. 2A, during time t10 to time t11 after completion of intake and prior to initiating discharge, power is supplied to the stepping motor 12, which rotates in the counterclockwise direction, displacing the displacing member 17 in the direction of decreasing the internal volume of the pump chamber 2. Conversely, during time t17 to time t18 after completion of discharge and prior to initiating intake, power is supplied to the stepping motor 12 which rotates in the clockwise direction, displacing the displacing member 17 in the direction of increasing the internal volume of the pump chamber 2.

In this correcting step, the valves 5a, 5b, 6a, 6b and the displacing member 17 can be actuated under control by the control unit 18, in accordance with preestablished conditions.

It is also possible to employ a method wherein during changeover from intake to discharge, and during changeover from discharge to intake, the pressure difference between locations to either side of the valves 5b, 6a that switch from the open state to the closed state is monitored either directly or indirectly; and during the correcting step, based on the monitoring results, the displacing member 17 is displaced in the direction eliminating the pressure difference.

Direct monitoring of the pressure difference between locations to either side of the valves 5b, 6a may be accomplished by positioning pressure sensors in the pump chamber 2, at a location in the inflow passage 3b to the outside of the valve 5b, and at a location in the outflow passage 4a to the outside of the valve 6a, and detecting pressure difference on the basis of detection results of these pressure sensors. Indirect monitoring of the pressure difference between locations to either side of the valves 5b, 6a may be accomplished by measuring the height location of the outflow port 40a of the outflow passage 4a, and monitoring the level of the second liquid LB shown in FIG. 3D.

In the mixing pump device 1 discussed above, when the stepping motor 12 turns in a first direction the displacing member 17 undergoes displacement in the direction for increasing the internal volume of the pump chamber 2, and when the stepping motor 12 turns in the opposite direction, the displacing member 17 undergoes displacement in the direction for reducing the internal volume of the pump chamber 2. Consequently, irrespective of the position of the displacing member 17, during the interval that the stepping motor 12 is turning in the first direction, a plurality of fluids can be suctioned into the pump chamber 2 in prescribed proportions simply by closing the active valves 6a, 6b positioned on the outflow passages 4a, 4b, and sequentially opening and closing the active valves 5a, 5b positioned on the inflow passages 3a, 3b. Then, during the interval that the stepping motor 12 is turning in the opposite direction, the mixed fluid can be discharged from the pump chamber 2 simply by closing the active valves 5a, 5b positioned on the inflow passages 3a, 3b, and opening one or both of the active valves 6a, 6b positioned on the outflow passages 4a, 4b. Thus, unlike a mechanism which transmits rotation of the stepping motor 12 to the displacing member 17 via a cam mechanism, there is no need to monitor cam position with a photointerrupter or the like. It is therefore possible to simplify the design of the mixing pump device 1, and make it smaller and less expensive.

It is a simple matter to modify the extent of displacement stroke of the displacing member 17 by varying the signal pattern presented to the stepping motor 12. A resultant advantage is that the extent of displacement stroke of the displacing member 17 can be set appropriately depending on the type of liquids being used.

The control unit 18 controls opening and closing of the active valves 5a, 5b, 6a, 6b in such a way that, of the first liquid LA and the second liquid LB which inflow from the inflow passages 3a, 3b, a portion of the second liquid LB having the larger mixture proportion flows into the pump chamber 2 prior to suctioning in the first liquid LA having the smaller mixture proportion. It is therefore possible to prevent the first liquid LA from becoming unevenly distributed in a corner of the pump chamber 2, e.g. in proximity to the active valve 5a, so as to achieve thorough mixing of the first liquid LA and the second liquid LB. In particular, more thorough mixing of the first liquid LA and the second liquid LB can be achieved because an amount equivalent to one-half of the total amount of the second liquid LB having the larger mixture proportion is suctioned into the pump chamber 2, then the first liquid LA having the smaller mixture proportion is suctioned into the pump chamber 2, and finally the remaining one-half of the second liquid LB is suctioned into the pump chamber 2.

The correcting step is executed during the interval from time t10 to time t11, and during the interval from time t17 to time t18. Even where the displacing member 17 has reached top dead center or bottom dead center, it will return from the top dead center or bottom dead center and perform intake or discharge. Accuracy of the intake amount and discharge amount is accordingly high. Particularly where the displacing member 17 is a diaphragm, during switchover from the discharging step to the suctioning step, or during switchover from the suctioning step to the discharging step, there is a tendency for displacement to occur in a non-responsive condition in which the internal volume of the pump chamber does not change despite deformation of the diaphragm, and for there to be variation in the intake amount and discharge amount. By interposing the correcting step, such variability can be eliminated.

Furthermore, where a diaphragm is employed as the displacing member 17, a pressure differential between the internal pressure of the pump chamber 2 and atmospheric pressure can produce unwanted deformation of the diaphragm. Since intake and discharge are carried out after correcting such deformation by executing the correcting step, accuracy of the intake amount and discharge amount is high.

Moreover, since the plurality of inflow passages 3a, 3b communicate mutually independently with the pump chamber 2, during passage of the first liquid LA through the inflow passage 3a for example, it is possible to avoid a situation where the first liquid LA becomes mixed with the second liquid LB prior to being suctioned into the pump chamber 2. Consequently, the amounts of the plurality of fluids flowing in from the inflow passages 3a, 3b can be controlled, and thus the mixture proportions of the first liquid LA and the second liquid LB can be controlled accurately.

Furthermore, it is also possible for the control unit 18 to control the opening and closing of the active valves 5a, 5b so that, of the first liquid LA and the second liquid LB flowing in from the inflow passages 3a, 3b, only one of the liquids will flow into the pump chamber 2. In this instance, it is possible for only the first liquid LA or the second liquid LB to be taken in, and for the liquid to be discharged from outflow passage 4a or the outflow passage 4b without being mixed with the other liquid.

[Specific Configuration Example of the Mixing Pump Device]

Next, a specific configuration example of a mixing pump device embodying the present invention will be described.

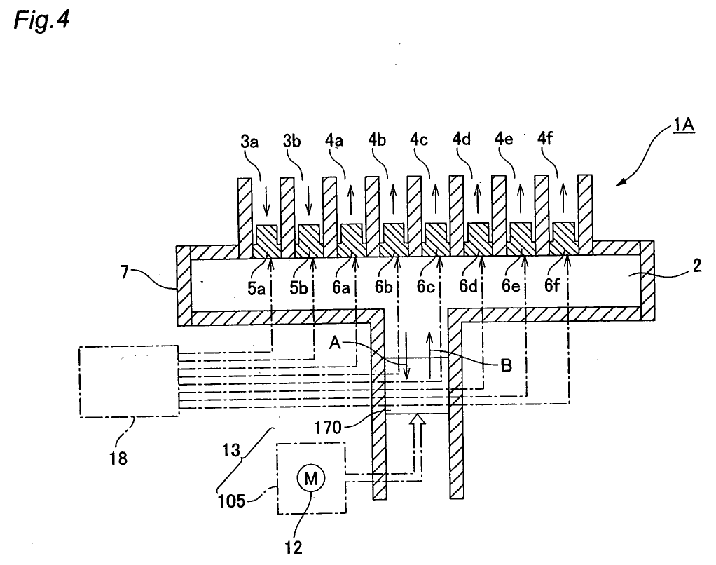

First, the basic design of the mixing pump device to be discussed hereinbelow shall be described with reference to FIG. 4 in order to reduce the level of complexity. Since the basic design of the mixing pump device of the present example is the same as that of the mixing pump 1 depicted in FIG. 1, corresponding parts have been assigned identical symbols in the drawing.

As shown in FIG. 4, the pump device main unit 7 of the mixing pump device 1A of the present example has a pump chamber 2, two inflow passages 3a, 3b communicating with the pump chamber 2, and six outflow passages 4a through 4f communicating with the pump chamber 2. The two inflow passages 3a, 3b and the six outflow passages 4a through 4f communicate mutually independently with the pump chamber 2. Inflow-side active valves 5a, 5b are positioned respectively on the two inflow passages 3a, 3b. Outflow-side active valves 6a through 6f are positioned respectively on the six outflow passages 4a through 4f.

The pump drive mechanism 13 has a diaphragm 170 that defines a portion of the inside peripheral surface of the pump chamber 2; a drive unit 105 equipped with a stepping motor 12 for displacing this diaphragm 170; and a control unit 18 for controlling opening and closing of the inflow-side active valves 5a, 5b and the outflow-side active valves 6a through 6f.

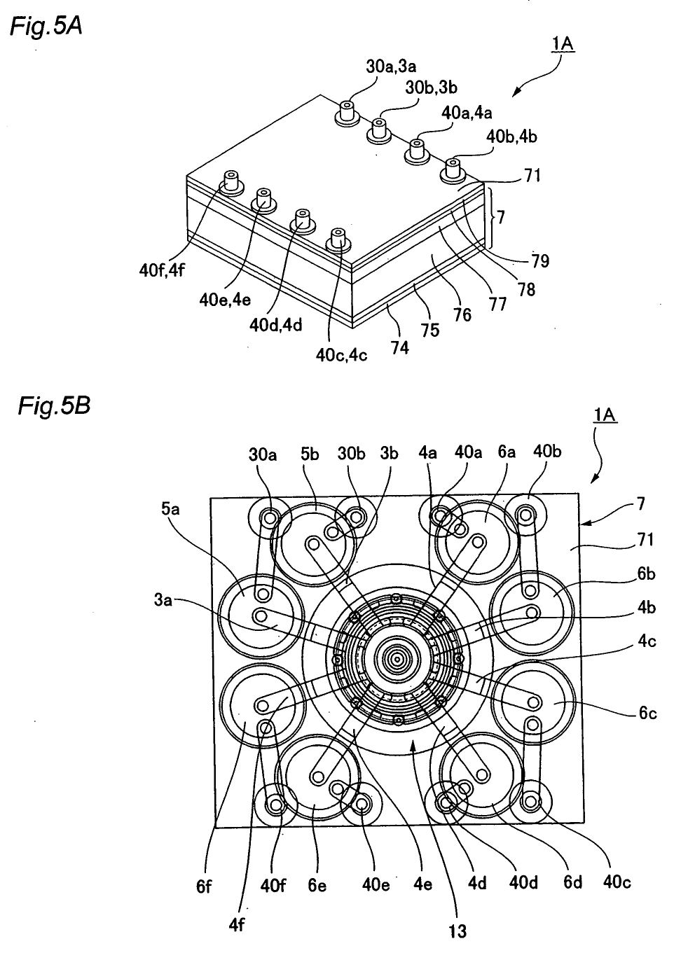

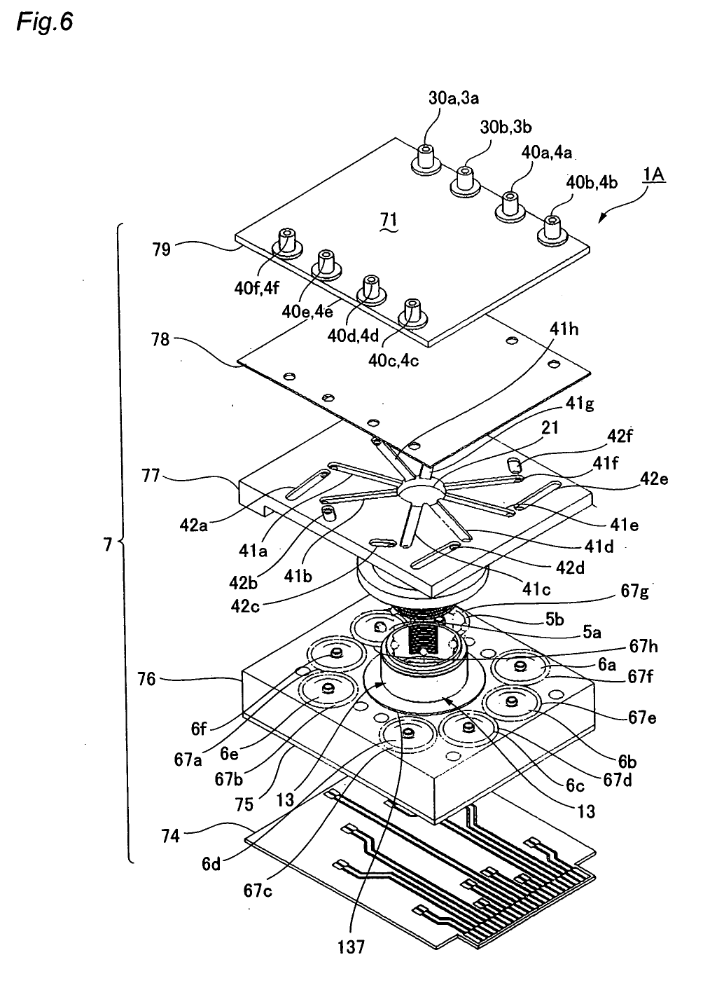

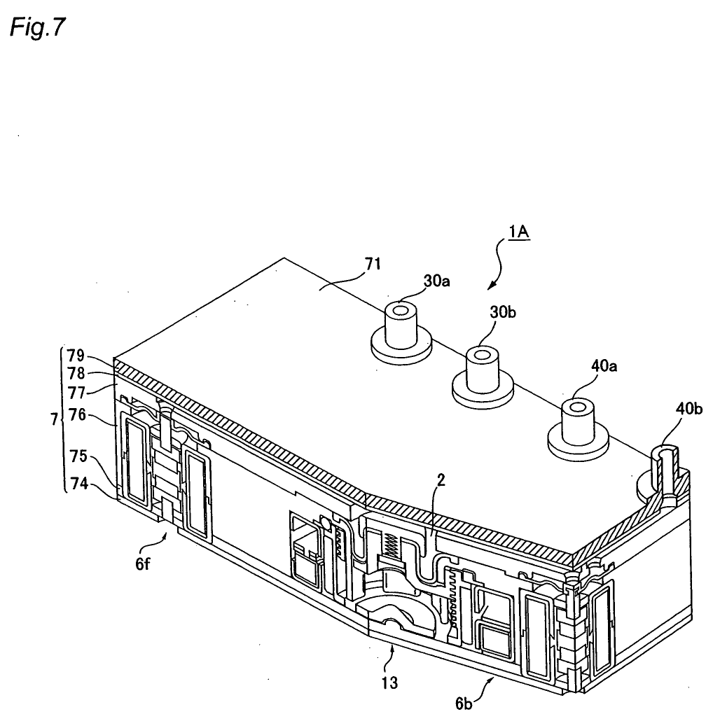

Next, FIG. 5A and FIG. 5B are respectively a perspective view and a plan view of the mixing pump device 1A. FIG. 6 is an exploded perspective view thereof; and FIG. 7 is a descriptive diagram showing the configuration thereof in cross section.

Reference to these drawings is made in the description provided hereunder. The mixing pump device 1A has pipes defining intake ports 30a, 30b and discharge ports 40a through 40f connected to one face 71 of the pump device main unit 7 which is in the shape of a box. The pump device main unit 7 has a stacked structure composed, in order, of a circuit board 74 for the pump drive mechanism 13 and the active valves 5a, 5b, 6a through 6f; a bottom plate 75; a base plate 76; a flow passage formation plate 77 having formed thereon flow passages of channel shape to be described later; a sealing sheet 78 for sealing off the upper sides of the flow passages via covering the upper face of the flow passage formation plate; and an upper plate 79 to which the aforementioned pipes are connected.

Holes 137, 67a through 67h providing installation spaces for the pump drive mechanism 13 and for the active valves 5a, 5b, and 6a through 6f are formed in the base plate 76. A round through-hole 21 constituting the pump chamber 2 is formed at a central location in the flow passage formation plate 77; and around this through-hole 21, on the lower face of the flow passage formation plate 77, are formed recesses (not shown) constituting the valve chambers of the active valves 5a, 5b, 6a through 6f. Eight channels 41a through 41h extend radially out from the through-hole 21. Additional channels 42a, 42b . . . , etc. are formed in proximity to the channels 41a through 41h of the flow passage formation plate 77.

The inflow passages 3a, 3b and the outflow passages 4a through 4f are formed by the eight channels 41a through 41h. Specifically, when the base plate 76, the flow passage formation plate 77, and the sealing sheet 78 are stacked, the inflow passages 3a, 3b and the outflow passages 4a through 4f are formed by the channels 41a through 41f, 42a, 42b . . . ; and the inflow-side active valves 5a, 5b and the outflow-side active valves 6a through 6f are positioned in the individual inflow passages 3a, 3b and outflow passages 4a through 4f.

Since the active valves 5a, 5b, 6a through 6f are positioned in a plane around the pump chamber 2, the flow passages in the individual inflow passages 3a, 3b and the outflow passages 4a through 4f are short, and the mixing pump device 1A can have a thin profile. Additionally, since variation in the amount discharged from the outflow passages 4a through 4f can be minimized, fluids can be discharged accurately in the proper amounts. Moreover, the length of the flow passage from the pump chamber 2 to the outflow-side active valves 6a through 6f is the same in each of the plurality of outflow passages 4a through 4f. Thus, outflow amounts via the outflow passages 4a through 4f can be controlled with high accuracy. Furthermore, since the inflow ports 30a, 30b and the outflow ports 40a through 40f open onto the same surface 71 of the pump device main unit 7, external connection of the mixing pump device 1A is a simple matter. Moreover, since the pump device main unit 7 is furnished with a flow passage formation plate 77 having inflow passages 3a, 3b and outflow passages 4a through 4f formed in the shape of a channel on one face thereof, and with a sealing sheet 78 that is positioned juxtaposed against this one face, a multitude of flow passages can be formed in a compact pump device main unit 7, and the mixing pump device 1A can be manufactured efficiently as well.

Furthermore, the two inflow passages 3a, 3b and the six outflow passages 4a through 4f have mutually identical design; and the inflow-side active valves 5a, 5b and the outflow-side active valves 6a through 6f have mutually identical design. Consequently, any of the inflow passages 3a, 3b and the outflow passages 4a through 4f can be utilized as the inflow passages 3a, 3b or the outflow passages 4a through 4f Consequently, [the mixing pump device] is not limited to two types of liquid, but can be used to mix and discharge three or more types of liquid.

(Detailed Design of the Pump Drive Mechanism)

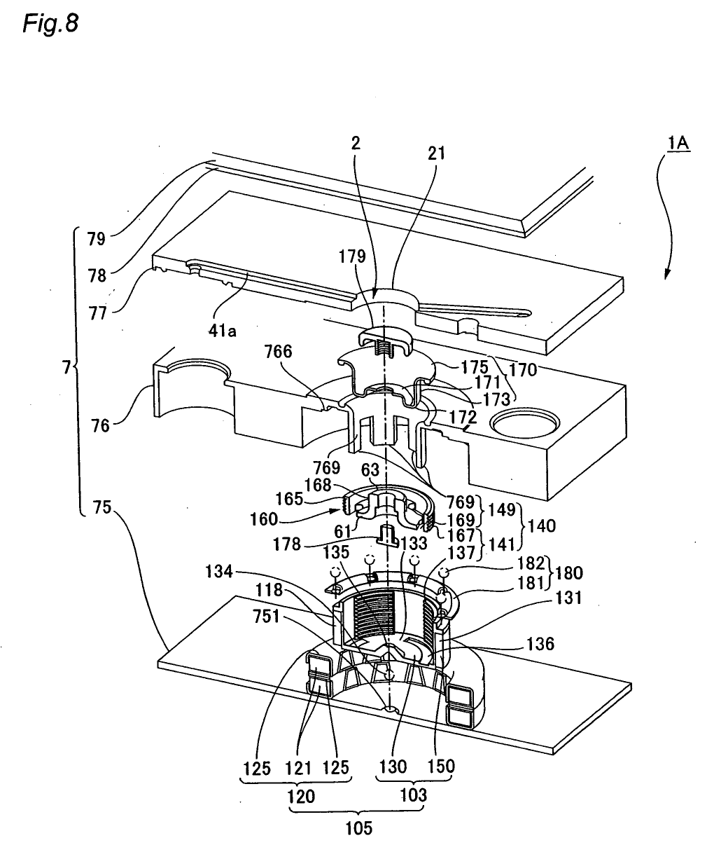

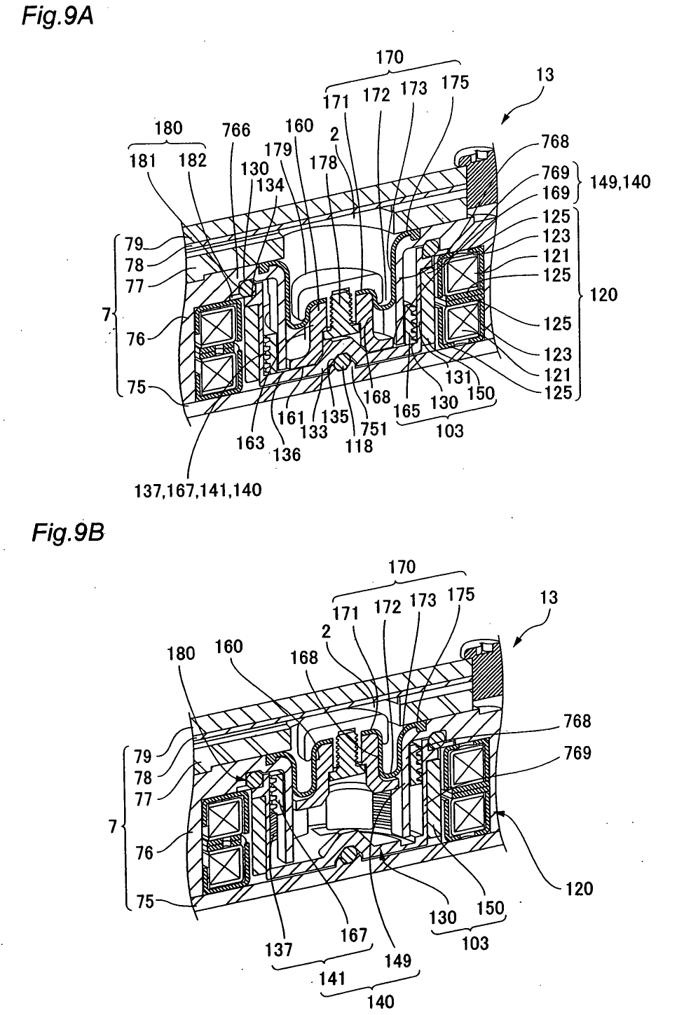

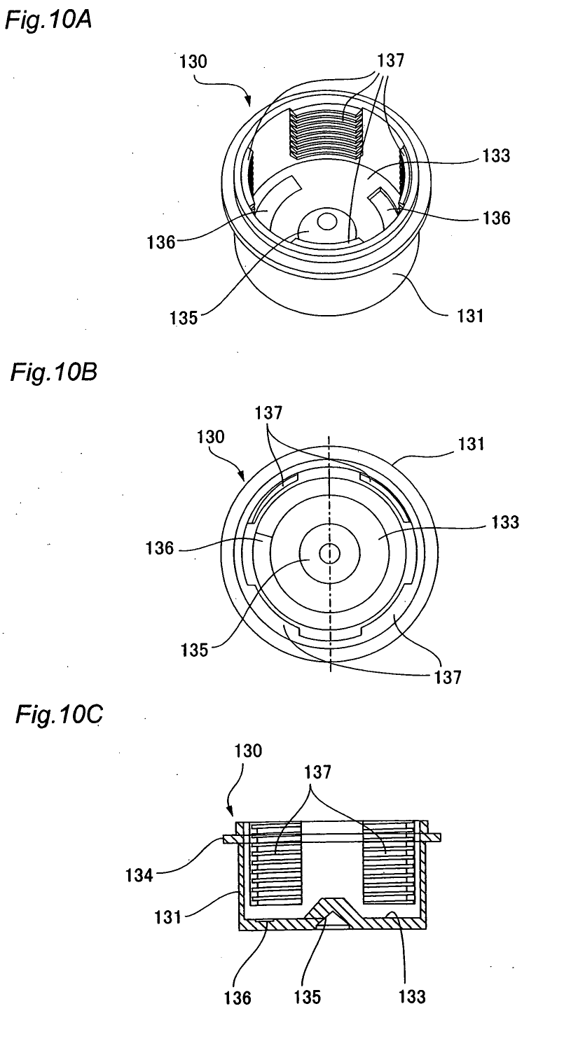

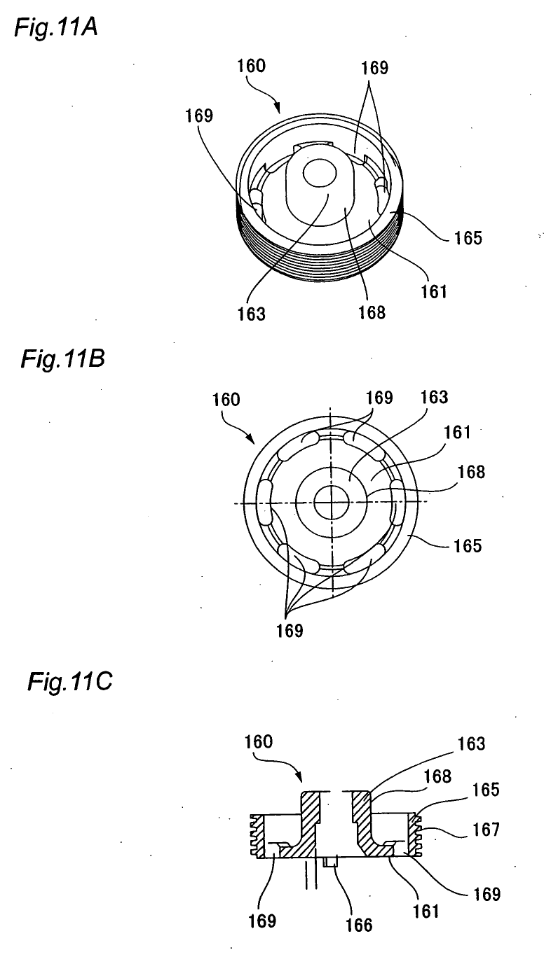

The pump drive mechanism 13 which is incorporated into the mixing pump device 1A will be described with reference to FIGS. 8 to 11. FIG. 8 is an exploded perspective view of the mixing pump device 1A, shown divided on the vertical. FIG. 9A and FIG. 9B are [respectively] a descriptive diagram of the pump chamber in the expanded state, and the pump chamber in the contracted state. FIGS. 10A to 10C are respectively a perspective view, a plan view, and a sectional view of a rotor employing the rotating body of the pump mechanism shown in FIG. 8. FIGS. 11A to 11C are respectively a perspective view, a plan view, and a sectional view of a moving body employing the rotating body of the pump mechanism shown in FIG. 8.

As shown in FIGS. 8 and 9A, the pump drive mechanism 13 is furnished generally with a diaphragm 170 that functions as the displacing member for taking in and discharging liquid by expanding and contracting the pump chamber 2 communicating with the inflow passages 3a, 3b and the outflow passages 4a through 4f; and a drive unit 105 for driving the diaphragm 170.

The drive unit 105 is furnished with an annular stator 120; a rotating body 103 disposed coaxially to the inside of this stator 120; a moving body 160 disposed coaxially to the inside of this rotating body 103; and a conversion mechanism 140 for converting rotation of the rotating body 103 to motion of the moving body 160 in the axial direction. The drive unit 105 is installed between the bottom plate 75 and the base plate 76, within a space formed in the base plate 76.

The stator 120 has a structure including a two-level stack of units each composed of a coil 121 wound around a bobbin 123, and a pair of yokes 125 positioned so as to cover the coil. In the each of two units in the upper and lower levels, the pole teeth which project in the axial direction from the inside peripheral edges of the pair of yokes 125 are arrayed in alternating fashion in the circumferential direction.

As shown in FIGS. 8, 9 and 10A through 10C, the rotating body 103 has a cup-shaped member 130 open at the top, and an annular rotor magnet 150 attached to the outside peripheral face of a cylindrical-shaped rotating body 103 drum portion 131 of the cup-shaped member 130. In the center of the floor 133 of the cup-shaped member 130 there is formed a recess 135 recessed upwardly in the axial direction; on the bottom plate 75 there is formed a bearing portion 751 adapted to receive a ball 118 that is positioned within the recess 135. An annular shoulder portion 766 is formed on the inside rim of the upper edge of the base plate 76. At the upper end portion of the cup-shaped member 130, an annular shoulder portion which faces towards the annular shoulder portion 766 on the base plate 76 is formed by the upper edge of the drum portion 131 and an annular flange 134. The annular space defined by these annular shoulder portions accommodates a bearing 180 which is composed of an annular retainer 181 and ball bearings 182 held at locations spaced apart in the circumferential direction by the retainer 181. In this way, the rotating body 103 is supported rotatably about the axis on the pump device main unit 7.

The outside peripheral face of the rotor magnet 150 faces towards the pole teeth which are lined up in the circumferential direction along the inside peripheral face of the stator 120. On the outside peripheral face of the rotor magnet 150, S poles and N poles are lined up in alternating fashion in the circumferential direction, with the stator 120 and the cup-shaped member 130 constituting the stepping motor.

As shown in FIGS. 8, 9, and 11A through 11C, the moving body 160 has a floor 161, a cylindrical portion 163 projecting out in the axial direction from the center of the floor 161, and a drum portion 165 of cylindrical shape formed so as to surround this cylindrical portion 163; a male thread 167 is formed on the outside periphery of the drum portion 165.

In order to constitute the conversion mechanism 140 for bringing about reciprocating movement of the moving body 160 in the axial direction by means of rotation of the rotating body 103, as shown in FIGS. 8, 9, 10A through 10C, and 11A through 11C, a female thread 137 is formed at four locations spaced apart in the circumferential direction, on the inside peripheral face of the drum portion 165 of the cup-shaped member 130. The male thread 167, which engages with the female thread 137 and constitutes a power transmission mechanism 141, is formed on the outside peripheral face of the drum portion 165 of the moving body 160. Consequently, the moving body 160 is supported to the inside of the cup-shaped member 130, with the moving body 160 positioned to the inside of the cup-shaped member 130 so that the male thread 167 meshes with the female thread 137.

On the floor 161 of the moving body 160 there are formed through-holes constituting six slots 169 along the circumferential direction; meanwhile, six projections 769 extend from the base plate 76, with the lower ends of the projections 769 fitting into the slots 169 and constituting a co-rotation preventing mechanism 149. Specifically, during rotation of the cup-shaped member 130, the moving body 160 is prevented from rotating by the co-rotation preventing mechanism 149 composed of the projections 769 and the slots 169; therefore, rotation of the cup-shaped member 130 will be transmitted to the moving body 160 via the power transmission mechanism 141 composed of the female thread 137 and the male thread 167 of the moving body 160, as a result of which the moving body 161 undergoes linear movement to one side or the other in the axial direction, depending on the direction of rotation of the rotating body 103.

(Configuration of Displacing Member)

Referring back to FIGS. 8 and 9A, the diaphragm 170 is linked directly to the moving body 160. The diaphragm 170, which is cup-shaped, has a floor 171; a drum portion 173 of cylindrical shape rising up in the axial direction from the outside peripheral edge of the floor 171; and a flange portion 175 spreading towards the outside periphery from the upper end of this drum portion 173. The diaphragm, with the center portion of the floor 171 thereof covering the cylindrical portion 163 of the moving body 160, is secured in place from above and below by a fastening screw 178 and a cap 179. The outside peripheral edge of the flange portion 175 of the diaphragm 170 is constituted by a thick section, which is adapted to ensure liquid-tightness, and also functions as a positioning section. The thick section is secured in place between the base plate 76 and the flow passage formation plate 77, around the through-hole 21 of the flow passage formation plate 77. In this way, the diaphragm 170 defines the lower face of the pump chamber 2, and assures liquid-tightness between the base plate 76 and the flow passage formation plate 77 around the pump chamber 2.

The drum portion 173 of the diaphragm 170 doubles back in a U shaped cross section, with the doubled back portion 172 thereof changing shape depending on the position of the moving body 160. The doubled back portion 172 having a U shaped cross section of the diaphragm 170 is positioned within a space of annular shape defined between a first wall face 168 composed of the outside peripheral face of the cylindrical portion 163 of the moving body, and a second wall face 768 composed of the inside peripheral faces of the projections 769 extended from the base plate 76. Consequently, with the diaphragm in any of the states shown in FIG. 9A or 9B, or during the process of moving between the states shown in these drawings, the doubled back portion 172 of diaphragm 170, while remaining retained within the annular space, undergoes deformation so as to expand or roll up along the first wall face 168 and the second wall face 768.

As shown in FIGS. 8, 9A, and 10A through 10C, a single groove 136 is formed on the floor 133 of the cup-shaped member 130 over an angular range of 270° in the circumferential direction, while a projection 166 is formed facing downward from the bottom face of the moving body 160. Here, the moving body 160 does not rotate about the axis but does move in the axial direction, while the rotating body 103 does rotate about the axis but does not move in the axial direction. Consequently, the projection 166 and the groove 136 function as a stopper for regulating the stop position of the rotating body 103 and the moving body 160. Specifically, the groove 136 changes in depth in the circumferential direction; as the moving body 160 moves downward in the axial direction the projection 166 will engage within the groove 136, and upon rotation of the rotating body 103, the edge of the groove 136 will come into abutment with the projection 166. As a result, the rotating body 103 will be prevented from rotating, thus regulating the stop position of the rotating body 103 and the moving body 160, i.e. the position of maximum expansion of the internal volume of the diaphragm 170.

(Operation of the Pump Drive Mechanism)

In the pump drive mechanism 13 of such a design, when power is supplied to the coil 121 of the stator 120, the cup-shaped member 130 rotates, and this rotation is transmitted to the moving body 160 via the conversion mechanism 140. Consequently, the moving body 160 undergoes linear reciprocating motion in the axial direction. As a result, the diaphragm 170 deforms in association with the motion of the moving body 160, causing the pump chamber 2 to expand or contract, whereby the inflow of liquid from the inflow passages 3a, 3b and the discharging of liquid to the outflow passages 4a through 4f take place in the pump chamber 2. During this time, the doubled back portion 172 of diaphragm 170, while remaining retained within the annular space, undergoes deformation so as to expand or roll up along the first wall face 168 and the second wall face 768, so no unnecessary sliding motion occurs. Moreover, even if the diaphragm 170 is subjected to pressure from the fluid in the pump chamber 2, the diaphragm is restricted both inside and out within the annular space, and thus will not deform. Furthermore, the lower position of the moving body 160 is restricted by the stopper composed of the groove 136 of the cup-shaped member 130 and the projection 166 of the moving body 160. Thus, the diaphragm 170 undergoes displacement with high accuracy, in association with the rotation of the cup-shaped member 130. In the drive unit 105, when the stepping motor rotates in one direction, the diaphragm 170 is displaced the direction of increasing the internal volume of the pump chamber 2; and when the stepping motor rotates in the other direction, the diaphragm 170 is displaced the direction of decreasing the internal volume of the pump chamber 2.

As discussed above, in the pump drive mechanism 13, rotation of the rotating body 103 by the stepping motor mechanism is transmitted to the moving body 160 via the conversion mechanism 140 which utilizes the power transmission mechanism 141 composed of the male thread 167 and the female thread 137, causing the moving body 160 to which the diaphragm 170 is fastened to undergo reciprocating linear motion. Thus, power is transmitted from the drive unit 105 to the diaphragm 170 by the minimum number of components needed to do so, whereby the pump drive mechanism 13 can be made smaller, thinner, and less expensive. Moreover, by giving the male thread 167 and the female thread 137 in the power transmission mechanism 141 a smaller lead angle, or by increasing the number of pole teeth of the stator on the drive end, it is possible for the moving body 160 to be advanced in very small increments. Consequently, the volume of the pump chamber 2 can be finely controlled, so metered discharge can be carried out with high accuracy.

Furthermore, the doubled back portion 172 of diaphragm 170, while remaining retained within the annular space, undergoes deformation so as to expand or roll up along the first wall face 168 and the second wall face 768, so no unnecessary sliding motion occurs. Consequently, no unnecessary load is produced, and the diaphragm 170 will have a longer life. Moreover, even if the diaphragm 170 is subjected to pressure from the fluid in the pump chamber 2, it will not deform. Therefore, the pump drive mechanism 13 can carry out metered discharge with high accuracy, and reliability is high as well.

Moreover, since the rotating body 103 is rotatably supported about the axis on the pump device main unit 7 via the ball bearings 182, sliding loss is minimal, and the rotating body 103 is held stably in the axial direction, stabilizing the thrust in the axial direction. It is therefore possible to make the drive unit 105 smaller, improve durability, and improve discharging ability.

While threads were employed for the power transmission mechanism 141 of the conversion mechanism 140, it is also possible to employ a cam mechanism instead. Furthermore, while a cup-shaped diaphragm has been used, a diaphragm of some other shape, or a piston equipped with an O-ring, can be used instead.

The numbers of intake ports and discharge ports may be different from those described hereinabove. A reflux port 90 has been provided, but can be omitted if the port is unnecessary. Furthermore, while the sealing sheet 78 for sealing off the upper face and the upper plate 79 to which the pipes are connected are formed by separate components, an arrangement that dispensed with the pipes of the upper plate 79 and provides only outflow holes to the sealing sheet 78, for connection via seal members would also be possible.

(Configuration of Active Valves)

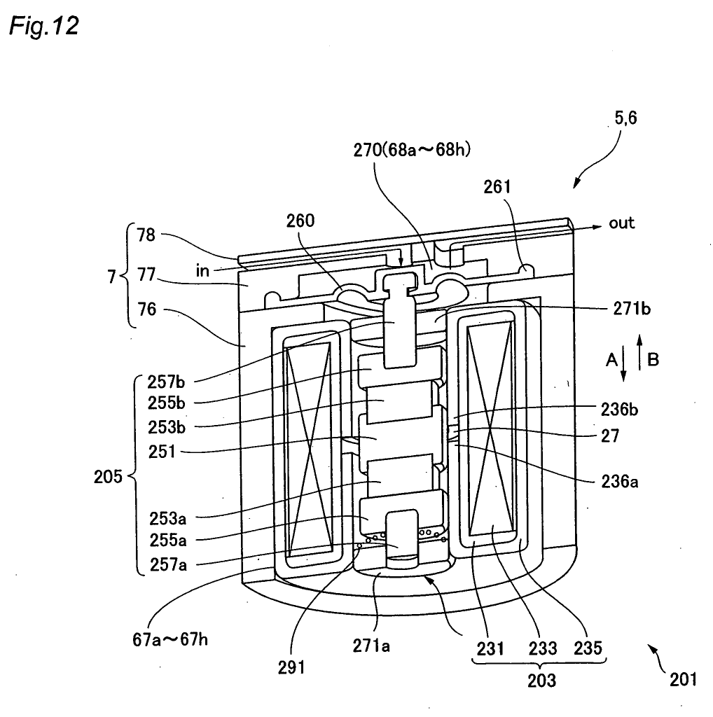

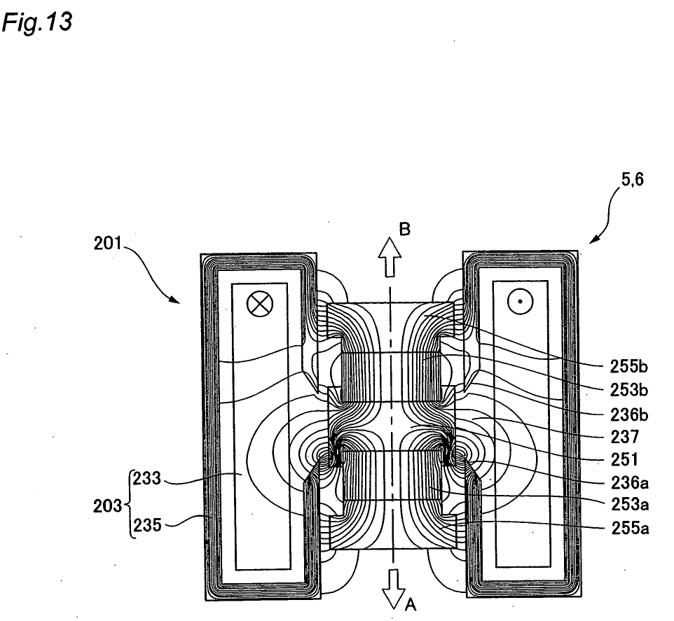

FIGS. 12 and 13 are, respectively, a descriptive diagram of the principal parts of a valve used for the active valves 5a, 5b and the active valves 6a through 6f of the mixing pump device 1A, shown cut along the axis and viewed from diagonally above; and a descriptive diagram of the lines of magnetic force thereof.

As shown in the drawings, the active valves 5a, 5b (hereinafter denoted as active valves 5) and the active valves 6a through 6f (hereinafter denoted as active valves 6) are provided with a linear actuator 201 positioned in the holes 57, 67a through 67h of the base plate 76; this linear actuator 201 has a stationary body 203 having a cylindrical shape, and a moveable body 205 having a round rod shape positioned inside the stationary body 203. The stationary body 203 has a coil 233 wound in annular configuration onto a bobbin 231; and a stationary body yoke 235 running around both sides of the coil in the axial direction from the outside peripheral face of the coil 233, with one distal edge 236a and the other distal edge 236b thereof facing in the axial direction across a slit 237, to the inside peripheral side of the coil 233. The movable body 205 has a first movable body yoke 251 having a disk shape, and a pair of magnets 253a, 253b stacked on either side of the first movable body yoke 251 in the axial direction. For the pair of magnets 253a, 253b it is possible to use Nd—Fe—B or Sm—Co rare earth magnets, or resin magnets. In the movable body 205, a second movable body yoke 255a, 255b is stacked on each of the pair of magnets 253a, 253b, on the end face thereof on the opposite side from the first movable body yoke 251.

The pair of magnets 253a, 253b are each magnetized in the axial direction, and oriented with the same pole facing the direction of the first movable body yoke 251. Here, the pair of magnets 253a, 253b are described as oriented with the N pole of each facing the direction of the first movable body yoke 251, and the S pole of each facing towards the outside in the axial direction; however, the direction of magnetization could be reversed.

The outside peripheral face of the first movable body yoke 251 protrudes out beyond the outside peripheral faces of the pair of magnets 253a, 253b. Likewise, the outside peripheral faces of the second movable body yokes 255a, 255b protrude out beyond the outside peripheral faces of the pair of magnets 253a, 253b.

Recesses are formed in each axial end of the first movable body yoke 251, and the pair of magnets 253a, 253b are fitted respectively into these recesses and secured there with adhesive or the like. It is acceptable to employ any arrangement in which the first movable body yoke 251, the pair of magnets 253a, 253b, and the second movable body yokes 255a, 255b are fastened through unification by an adhesive, press-fitting, or a combination of these.

Bearing plates 271a, 271b (bearing members) are fastened in openings at either axial end of the stationary body 203, and spindles 257a, 257b which project out to either side in the axial direction from the second movable body yokes 255a, 255b are each slidably inserted into holes in the bearing plates 271a, 271b. In this way, the movable body 205 is supported on the stationary body 203 so as to be capable of reciprocating motion in the axial direction. In this state, the movable body 205 faces the inside peripheral face of the stationary body 203 across a prescribed gap, with the distal edges 236a, 236b of the stationary body yoke 235 facing one another in the axial direction within the gap between the outside peripheral face first movable body yoke 251 and the inside peripheral face of the coil 233. A gap is maintained between the moveable body 205 and the stationary body yoke 235 as well. It is acceptable to employ any arrangement in which the second movable body yokes 255a, 255b and the spindles 257a, 257b are fastened through unification by an adhesive, press-fitting, or a combination of these.

In the linear actuator 201 of the design described above, for the period that electrical current, on the right side when facing the drawing, is flowing through the coil 233 towards the viewer from the far side and, on the left side facing the drawing, is flowing away from the viewer and towards the far side, the lines of magnetic force will be as depicted in FIG. 13. Accordingly, the moveable body 5 is first subjected to thrust and moves in the axial direction due to Lorentz force, as indicated by arrow A. On the other hand, when the direction of current through the coil 233 reverses, the moveable body 205 will descend along the axial direction as indicated by arrow B.

In the linear actuator 201, the moveable body 205 is propelled by magnetic force, and a frustoconically shaped coil spring 291 is positioned as an urging member between the bearing plate 271a and the second movable body yoke 255a, on one side in the axial direction. Consequently, the moveable body 205 descends while deforming the compression spring; and as the moveable body 205 moves at high speed when ascending, assisted by the shape recovery force of the compression spring.

In the linear actuator 201 designed in this manner, the center portion of a diaphragm valve 260 positioned in the valve chamber 270 (recess 68a through 68h) is connected to the end of one of the spindles 257b. An annular thick section 261 providing liquid-tightness and a positioning function is formed on the outside periphery of the diaphragm 260; the outside peripheral section of the diaphragm 260 including this annular thick section 261 is held between the base plate 76 and the flow passage formation plate 77, ensuring liquid-tightness.

The displacing member is not limited to a diaphragm 260, it being possible to employ a bellows valve or some other valve instead. An arrangement in which the spindles 257a, 257b and the displacing member are separate components connected together, or an arrangement in which the spindles 257a, 257b and the displacing member are formed integrally, is acceptable.

As discussed above, the pair of magnets 253a, 253b in the moveable body 205 are oriented with identical poles facing one another, producing magnetic repulsive force, but since the first movable body yoke 251 is positioned between the magnets 253a, 253b, the pair of magnets 253a, 253b can be secured oriented with identical poles facing one another.

Also, since the pair of magnets 253a, 253b in the moveable body 205 [are oriented] with identical poles facing the first movable body yoke 251, strong magnetic flux is generated in the radial direction from the first movable body yoke 251. Accordingly, where the peripheral faces of the first movable body yoke 251 and the coil 233 are juxtaposed, the moveable body 205 can be imparted with strong thrust.

Since the magnets 253a, 253b need only be magnetized in the axial direction, in contrast to the case where the magnets 253a, 253b are magnetized in the radial direction, magnetization is a simple matter even where the magnets are small, which is suitable for mass production purposes.

Moreover, since the outside peripheral face of the first movable body yoke 251 protrudes out beyond the outside peripheral faces of the pair of magnets 253a, 253b, the magnetic attracting force acting in the axial direction and the perpendicular direction on the moveable body 205 can be minimized, even if the stationary body yoke 235 is provided. Similarly, since the outside peripheral faces of the second movable body yokes 255a, 255b protrude out beyond the outside peripheral faces of the pair of magnets 253a, 253b, the magnetic attracting force acting in the axial direction and the perpendicular direction on the moveable body 205 can be minimized, even when the stationary body yoke 235 is provided. The assembly operation is facilitated and the moveable body resists tilting, which are advantages obtained as a result.

Since the magnets 253a, 253b are positioned at the outside periphery side in the coil 33, the magnets 253a, 253b can be smaller, and the active valves 5, 6 may be designed less expensively, as compared to when the magnets 253a, 253b are positioned outwardly from the coil 233. Also, since the coil 233 is positioned to the outside, the magnetic path can be closed with the stationary yoke only.

Furthermore, in the stationary body 203, since the bearing plates 271a, 271b for supporting the spindles 257a, 257b so as to be moveable in the axial direction are held in openings that open in the axial direction, there is no need for separate bearing members. An additional advantage is that since the bearing plates 271a, 271b can be secured on the basis of the stationary body 203, the spindles 257a, 257b will not tilt.

[Fuel Cell Equipped with Mixing Pump Device]

An example will be described using the mixing pump device of the present invention as a fuel delivery unit for delivering fuel to the electromotive portion of a fuel cell.

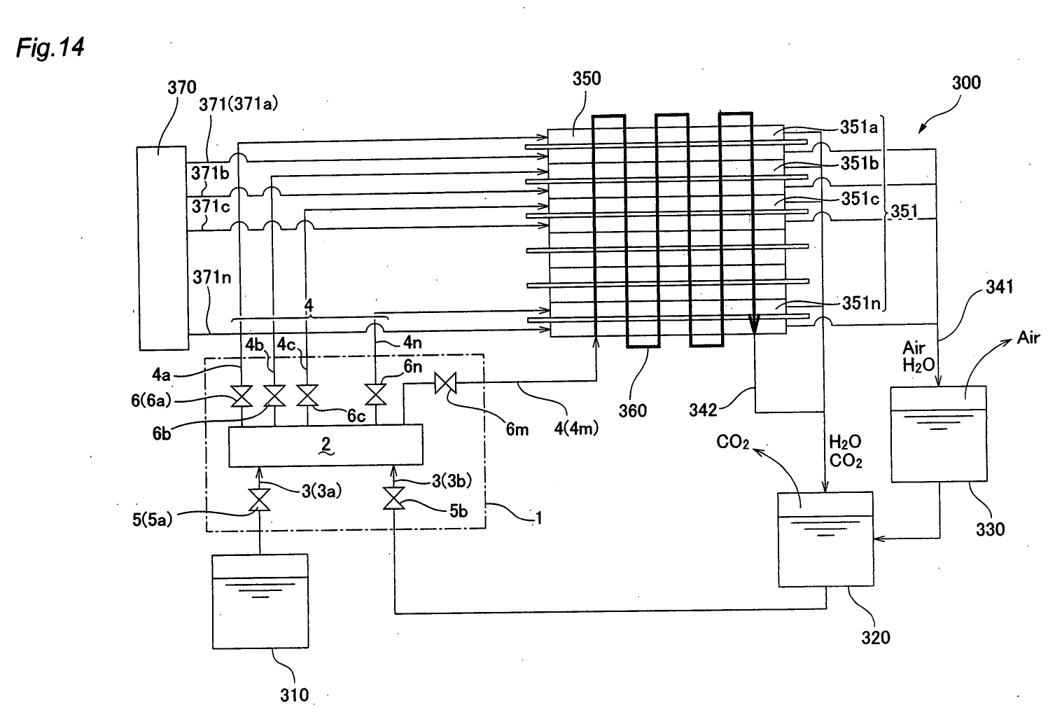

FIG. 14 is a block diagram depicting in model form the structure of a fuel cell employing the mixing pump device of the present invention. The fuel cell 300 shown in FIG. 14 is a direct methanol type of fuel cell for generating electricity by taking protons directly from a methyl alcohol aqueous solution (fuel/hydrogen-containing fluid capable of generating protons). In the fuel cell 300, methyl alcohol is used as the unprepared fuel, water is used as the diluent, and these are mixed to prepare a methyl alcohol solution of optimal concentration for use as the fuel. In some instances, an alcohol aqueous solution of higher concentration than the optimal concentration will be used as the unprepared fuel.

The fuel cell 300 is furnished with the mixing pump device 1 described previously with reference to FIGS. 1 to 13; an unprepared fuel tank 310 connected to the inflow passage 3a of the mixing pump device 1; a diluent tank 320 connected to the inflow passage 3b of the mixing pump device 1; and a generating unit 350; the outflow passages 4a through 4n of the mixing pump device 1 are connected independently to the electromotive portions 351a through 351n of the generating unit 350. Methyl alcohol is stored as the unprepared fuel in the unprepared fuel tank 310, and water is stored as the diluent in the diluent tank 320. Accordingly, the inlet passage 3a corresponds to the unprepared fuel inlet passage, and the inlet passage 3b corresponds to the diluent inlet passage.

The fuel cell 300 is also furnished with an air delivery unit 370. Air outflow passages 371a through 371n are connected to the air delivery unit 370; air is delivered from the air outflow passages 371a through 371n to the cathode electrodes of the electromotive portions 351a through 351n.

While a detailed illustration is not provided, each of the plurality of electromotive portions 351a through 351n has an anode (fuel electrode) with an anode collector and an anode catalyst layer; a cathode (air electrode) with a cathode collector and a cathode catalyst layer; and an electrolyte membrane positioned between the anode and the cathode. At the anode, fuel (a methanol aqueous solution) prepared to a prescribed concentration by the mixing pump device 1 is delivered, and hydrogen ions (protons, H⁺) and electrons (e⁻) are formed by means of the reaction indicated below:

CH₃OH+H₂O→CO₂+6H⁺+6e⁻

The electrons travel from the anode through a circuit to the cathode, while the hydrogen ions permeate the electrolyte membrane, and move towards the cathode, where they react with air (oxygen) delivered to the cathode by an air pump or blower, to form water by the electrochemical reaction indicated below:

3/2O₂+6H⁺+6e⁻→3H₂O

In the fuel cell 300, the electromotive portions 351a through 351n produce heat, and this heat can be the cause of deterioration or a drop in the generating efficiency of the electromotive portions 351a through 351n. For this reason, a water cooled type of cooling unit 360 is provided for the generating unit 350 in the fuel cell 300. In addition to the outflow passages 4a through 4n for delivering fuel, the mixing pump device 1 is furnished with an outflow passage 4m for delivering cooling water, as the coolant outflow passage.

In the mixing pump device 1, active valves 5a, 5b are positioned respectively on the plurality of inflow passages 3a, 3b; and active valves 6a through 6n are positioned respectively on the plurality of outflow passages 4a through 4n.

In the fuel cell 300, there is also provided a recovery tank 330 for recovering the water which has evolved at the cathode in the electromotive portions 351a through 351n, and the evolved water recovered in the recovery tank 330 is delivered to the diluent tank 320. In some instances, a condenser is provided at a location along the line 341 leading from the electromotive portions 351a through 351n to the recovery tank 330.

Furthermore, in the fuel cell 300, water discharged from the cooling unit 360 is also delivered to the diluent tank 320. While cooling of the water discharged from the cooling unit 360 may take place through natural cooling, it would also be possible to provide a radiator or other cooler at a location on the line 342 leading from the cooling unit 360 to the diluent tank 320, or on the outflow passage 4m for delivering cooling water from the mixing pump device 1. Coolers having radiators and the like could also be provided at locations along both the line 342 and the outflow passage 4m.

In the fuel cell 300 of the design described above, the methyl alcohol stored in the unprepared fuel tank 310 is introduced into the pump chamber 2 of the mixing pump device 1 via the inflow passage 3a, while the water stored in the diluent tank 320 is introduced into the pump chamber 2 of the mixing pump device 1 via the inflow passage 3b. During this time, by setting the amount of introduced methyl alcohol and the amount of introduced water to prescribed proportions, a methanol aqueous solution (fuel) of optimal concentration is prepared, and fuel prepared to optimal concentration is delivered to the electromotive portions 351a through 351n via the fuel delivery outflow passages 4an through 4n, to be used for generating electricity. Once the water that has evolved at the cathode of the electromotive portions 351a through 351n has been recovered in the recovery tank 330, it is delivered to the diluent tank 320 for reuse as diluent. During this time, the outflow passage 4m for cooling water delivery is in the closed state.

Pauses in delivery of fuel to the electromotive portions 351a through 351n are utilized for cooling. During these times, only water stored in the diluent tank 320 is introduced via the inflow passage 3b into the pump chamber 2 of the mixing pump device 1, and water is delivered to the cooling unit 360 via the cooling water delivery outflow passage 4m. The water discharged from the cooling unit 360, after being recovered in the recovery tank 330, is delivered to the diluent tank 320 for reuse as diluent. During this time, introduction of methanol into the pump chamber 2 via the inflow passage 3a and delivery of fuel via the outflow passages 4a through 4n are halted.

As described above, in the fuel cell 300, since the generating unit 350 is composed of the electromotive portions 351a through 351n, the generated voltage is high. Specifically, since methanol oxidation activity is low at the anode of the electromotive portions 351a through 351n, and there is voltage loss at the cathode as well, the output drawn from any single electromotive portion will be low; however, since the fuel cell 300 is furnished with a plurality of electromotive portions 351a through 351n, the generated voltage is high.

In the mixing pump device 1, the control unit 18, by control of the active valves 5a, 5b, the active valves 6a through 6m, and the displacing member 17 (see FIG. 1), and control of the inflow amounts of methyl alcohol and water from the inflow passages 3a, 3b, is able to control the mixture proportions of methyl alcohol and water, and the discharged amounts from the outflow passages 4a through 4n. Consequently, fuel prepared to optimal concentration by diluting methyl alcohol with water can be delivered at any desired timing to the plurality of electromotive portions 351a through 351n.

Furthermore, in the fuel cell 300, water that has evolved at the cathode in the electromotive portions 351a through 351n is recovered in the recovery tank 330 and can be reused as water for diluting. Consequently, release of water can be kept to a minimum, and it is possible to generate electricity continuously simply by supplying only methyl alcohol as the unprepared fuel, without the need to supply water from the outside.

Additionally, in the mixing pump device 1, the control unit 18, by controlling the active valves 5a, 5b and the active valves 6a through 6n, can draw in water to the pump chamber 2 from the inflow passage 3b and deliver it to the cooling unit 360 from the cooling water delivery outflow passage 4m, eliminating the need for a dedicated cooling water supply unit. Moreover, in the fuel cell 300, cooling water that has cooled the electromotive portions 351a through 351n can be delivering the diluent tank 320, for reuse as water for diluting. Consequently, release of water can be kept to a minimum.

While water has been used as the diluent, it would alternatively be possible to use a methyl alcohol aqueous solution of lower concentration than the optimal concentration as the diluent. In this case, the methyl alcohol aqueous solution of low concentration may be used as the coolant, and the methyl alcohol aqueous solution of low concentration used as the coolant may be delivered to the diluent tank 320 for reused as diluent.

While the use of an individual diluent tank 320 and recovery tank 330 for recovering evolved water has been described, it is possible for the same tank [to serve as both] the recovery tank 330 and diluent tank 320.

While a methyl alcohol aqueous solution has been used as the fuel, it is alternatively possible to use an ethyl alcohol aqueous solution, or an aqueous solution containing both a methyl alcohol aqueous solution and an ethyl alcohol aqueous solution. It is also possible to use pure methyl alcohol or pure ethyl alcohol, or a solution containing both pure methyl alcohol and pure ethyl alcohol. It is also possible to use as fuel an aqueous solution of an alcohol other than a methyl alcohol aqueous solution, for example, an ethylene glycol aqueous solution; or to use an aqueous solution other than an alcohol aqueous solution, e.g. a dimethyl ether aqueous solution. It is also possible to use as fuel an alcohol other than pure methyl alcohol, for example, pure ethylene glycol.

[Other Applications of the Mixing Pump Device]

Applications involving the mixing pump device embodying the present invention are not limited to fuel cells. The device can be used as pump for blending a plurality of chemical solutions in order to blend a compound chemical. It can also be used as a refrigerator icemaker pump, for discharging from discharge paths sherbets of different color and flavor for each icemaker block.

### OTHER EMBODIMENTS

While the preceding embodiment focused on the example of using a diaphragm 170 as the displacing member 17, the invention can instead be embodied in a mixing pump device of a type using a plunger as the displacing member. Also, while the preceding embodiment was an example designed with a plurality of outflow passages, the invention can instead be embodied in a mixing pump device having a single outflow passage.

In the preceding embodiment, the invention was embodied in a mixing pump device, but the invention can also be embodiment in a metering pump for discharging a single type of liquid.

1. A mixing pump device comprising:
a pump chamber;
a displacing member disposed in the pump chamber, for increasing and reducing the internal volume of the pump chamber;
a drive unit having a motor for inducing displacement of the displacing member;
a plurality of inflow passages communicating with the pump chamber;
at least one outflow passage communicating with the pump chamber;
inflow valves disposed on the inflow passages, for independently opening and closing the inflow passages;
an outflow valve for opening and closing the outflow passage; and
a control unit for controlling the drive unit, the inflow valves, and the outflow valve;
wherein the drive unit induces displacement of the displacing member in a direction for increasing the internal volume of the pump chamber when the motor turns in a first direction; and induces displacement of the displacing member in a direction for reducing the internal volume of the pump chamber when the motor turns in a second direction.

2. The mixing pump device of claim 1 wherein a plurality of the outflow passages communicate with the pump chamber, and the outflow valves are positioned on the respective outflow passages.

3. The mixing pump device of claim 1 wherein the inflow passages and the outflow passages communicate mutually independently with the pump chamber.

4. The mixing pump device of claim 1 wherein the displacing member is a diaphragm.

5. The mixing pump device of claim 1 wherein during the suctioning step, in which the displacing member is induced to undergo displacement in the direction for increasing the internal volume of the pump chamber with the outflow valve closed, the control unit controls opening and closing of the inflow valves so that before the fluid having the lowest mixture ratio among the fluids flowing in from the respective inflow passages flows into the pump chamber, at least some fluid having a larger mixture ratio than that fluid flows into the pump chamber.

6. The mixing pump device of claim 1 wherein the control unit controls the amount of fluids flowing into the pump chamber from the inflow passages, thereby controlling both the mixture ratios of the fluids constituting the mixed fluid formed in the pump chamber, and the amount of mixed fluid discharged from the pump chamber to the outflow passage.

7. A fuel cell having:
an electromotive part; and
a fuel delivery device for delivering fuel to the electromotive part, wherein
the fuel delivery device is the mixing pump device of claim 1.

8. The fuel cell of claim 7 wherein the fuel is a hydrogen-containing fluid capable of generating protons.

9. The fuel cell of claim 8 wherein the hydrogen-containing fluid contains an alcohol.

10. The fuel cell of claim 8 wherein the hydrogen-containing fluid contains methyl alcohol and/or ethyl alcohol.

11. The fuel cell of claim 7 further comprising an unprepared fuel tank for delivering unprepared fuel to the pump chamber of the mixing pump device;
wherein the plurality of inflow passages has an unprepared fuel inflow passage for the unprepared fuel delivered from the unprepared fuel tank to flow into the pump chamber, and a diluent inflow passage for a diluent containing water to flow into the pump chamber.

12. The fuel cell of claim 11 wherein water containing evolved water that evolved in the electromotive portion is delivered into the pump chamber via the diluent inflow passage.

13. The fuel cell of claim 11 wherein a plurality of the outflow passages communicate with the pump chamber; and
these outflow passages have a coolant outflow passage for delivering a coolant to the electromotive portion.

14. The fuel cell of claim 13 wherein the inflow passage is used for delivering water into the pump chamber; and
the coolant outflow passage delivers cooling water as the coolant to the electromotive portion.

15. The fuel cell of claim 11 having a water tank connected to the diluent inflow passage,
wherein at least the evolved water is stored in the water tank.

16. The fuel cell of claim 11 wherein the fuel is a hydrogen-containing fluid capable of generating protons.

17. The fuel cell of claim 16 wherein the hydrogen-containing fluid has an alcohol.

18. The fuel cell of claim 16 wherein the hydrogen-containing fluid has methyl alcohol, ethyl alcohol, or both.
